(19) United States
(12) Patent Application Publication
(10) Pub. No.: US 2018/0093386 A1
(43) Pub. Date: Apr. 5, 2018

(54) CORNER PUNCH DEVICE

(71) Applicant: Hewlett-Packard Development Company, L.P., Houston, TX (US)

(72) Inventors: Francois K. Pirayesh, San Diego, CA (US); Xiaoqi Zhou, San Diego, CA (US); David Edmondson, San Diego, CA (US)

(21) Appl. No.: 15/563,843

(22) PCT Filed: Jul. 13, 2015
(86) PCT No.: PCT/US2015/040220

§ 371 Date: Oct. 2, 2017

(51) Int. Cl. B26D 3/10; B26F 1/04; B26D 1/06; B26F 1/14

(52) U.S. Cl. CPC B26D 3/10; B26F 1/14; B26D 1/065; B26F 1/04

(57) ABSTRACT

In an example implementation, a corner punch device includes a base and a handle rotatably coupled to the base. A die piece is fixed to the base, and a punch piece is moveable by the handle toward the die piece. The punch piece comprises multiple punch profiles that are active to punch distinct shapes into separate media sheets simultaneously.

### BACKGROUND

Media sheets, such as greeting cards, photo print paper, paper sheets with text and/or graphics, and other types of media cards, are usually produced and sold in the form of rectangular sheets having corners with right angles. This form, having right angled corners, helps to reduce manufacturing costs of the media sheets. However, consumers of such media sheets often desire different forms, such as forms having a variety of differently shaped corners. Manufacturing media sheets to have differently shaped corners involves increased costs in machine tooling and labor.

### BRIEF DESCRIPTION OF THE DRAWINGS

Examples will now be described with reference to the accompanying drawings, in which:

FIG. 1 is a drawing in perspective view that illustrates an example of a corner punch device for punching differently shaped corners into media sheets;

FIG. 2 is a drawing showing an example corner punch device with some of its components separated from one another;

FIG. 3 shows a portion of the base of an example corner punch device;

FIG. 4 shows an example of a sample media sheet being positioned within a media guide area of an example corner punch device;

FIG. 5 shows a perspective view and a top down view of an example punch piece for an example corner punch device;

FIG. 6 shows a top down view of an example die piece that corresponds with the example punch piece of FIG. 5;

FIG. 7 shows an example of a process of punching a corner of a media sheet;

FIG. 8 shows an example of a base component of a corner punch device comprising four media guide areas to accommodate four corner punch profiles;

FIG. 9 shows an example of a punch piece and die piece of an example corner punch device that comprise four corresponding corner punch profiles.

Throughout the drawings, identical reference numbers designate similar, but not necessarily identical, elements.

### DETAILED DESCRIPTION

Market research indicates customers of some printable materials favor media sheets that have decorative corner shapes, such as rounded corners and other-shaped corners, instead of the usual square-shaped corners that are provided on rectangular media sheets. Furthermore, customers often desire differently shaped media sheets to be included within the same, or single media package. Examples of such media sheets include greeting cards, photographic print paper, paper sheets with text and/or graphics, and other types of media cards and card stock paper in a variety of sizes and weights. As noted above, manufacturing media sheets to have differently shaped corners involves increased costs related to machine tooling and labor. The increase in costs is even greater when differently shaped media sheets are to be provided within the same, or single media package.

One way to provide customers with media sheets having differently shaped corners is to offer a corner cutting device within the package of media sheets, or as a separate, stand-alone device. Providing a corner cutting device to enable the customer to cut differently shaped corners into the media sheets can be more cost effective than manufacturing the media sheets with differently shaped corners. A variety of such media sheet, corner cutting devices are known. Examples of existing corner cutting devices include those having cutting elements to cut a corner from the media sheet when operated in conjunction with a handle or other moveable structure. A base structure biased with respect to the moveable handle can receive the media sheet and enable the cutting element to cut a corner from the sheet as the handle and base converge. In some devices, the cutting element can be disassembled and/or removed from the device to enable the installation of an alternate cutting element having a different cutting shape or profile. In other devices, the cutting element can be rotated or repositioned within the device to enable access to a different cutting profile of the cutting element.

While currently available corner cutting devices offer customers some alternatives to rectangular media sheets having right-angled corners, these devices can be costly and inconvenient to use. For example, the cutting elements used in some devices have numerous components that can be complicated to assemble, disassemble, remove, replace, and so on. Such complicated cutting elements tend to increase the overall cost of the device. In addition, many devices are limited to cutting a single corner shape into one or multiple media sheets at a time, which can be inconvenient for users who want to create multiple finished sheets with varying corner shapes. Furthermore, devices that offer more than one cutting shape, or cutting profile, generally involve user interaction with the device in order to activate, access, or alternate between, the different cutting profiles.

Accordingly, examples of media corner punching devices are described herein that provide a lower cost and convenient solution for users who want to generate multiple media sheets having multiple, differently-shaped corners. In one example, a corner punch device includes a base for support, and a handle that is rotatably coupled to the base. A die piece is fixed to the base, and a punch piece is moveable by the handle toward the die piece. The punch piece comprises multiple punch profiles that are all active to punch distinct shapes into separate media sheets simultaneously. The multiple punch profiles remain active and exposed so that they are immediately and persistently available for simultaneous corner punching without user involvement to alter or manipulate the device in order to expose, activate, or otherwise enable the different profiles. Thus, example corner punch devices enable a user to form differently shaped corners in more than one media sheet at a time. In one such example, a corner punch device provides four corner punching profiles, enabling the user to generate four media sheets at the same time that each have a different corner shape.

In another example, a device for punching a corner of a media sheet includes a punch piece, and a die piece to receive the punch piece. A base supports the die piece, and a handle is hinged to the base to enable pressing the punch piece into the die piece to form a different corner shape on each of multiple media sheets at the same time. The punch and die pieces have multiple corresponding profiles that punch different corner shapes into different media sheets with a single rotation of the handle that presses the punch piece into the die piece.

In another example, a corner punch device includes multiple media guide areas to receive multiple media sheets. Media guides positioned at the edges of each media guide area guide the corners of the media sheets into a punching position in the device. Each media guide area is associated with, and guides media toward, a distinct punch and die profile. The device includes a handle to press a punch piece into a die piece to punch the corners of the media sheets with shapes that correspond to the distinct punch and die profiles.

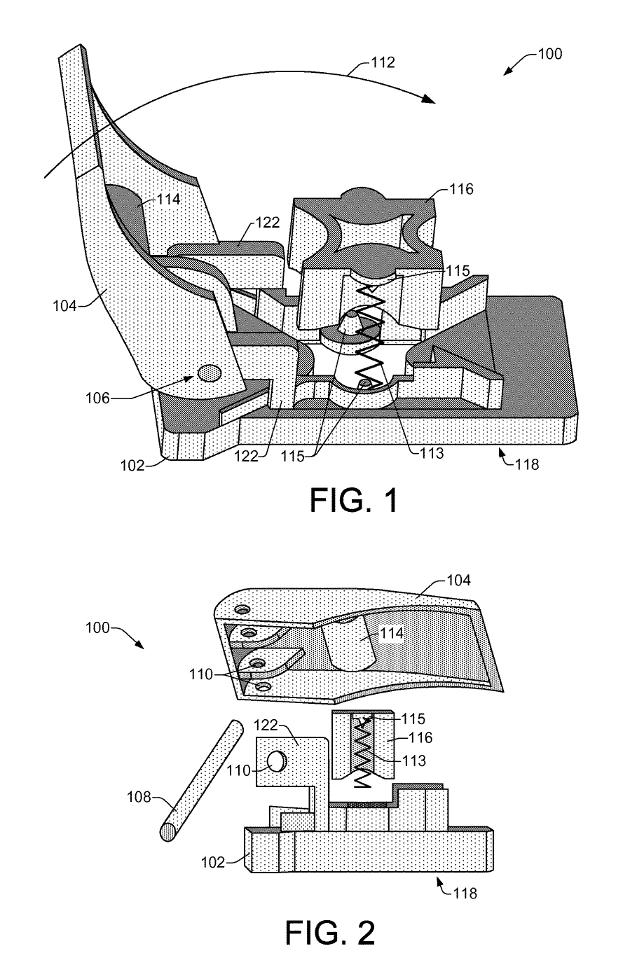

FIG. 1 is a drawing in perspective view that illustrates an example of a corner punch device 100 for punching differently shaped corners into media sheets. The corner punch device 100 comprises components whose movement with respect to one another creates a perforating action that punches out the corners of media sheets (i.e., pieces of sheet material), leaving the media sheets with corners that are shaped like one of the multiple profiles of the punching component. The punching process of the device 100 is similar to a metal fabricating process referred to as blanking. In a blanking process, a metal piece is removed from a primary metal sheet when it is punched. The metal piece that is removed is often referred to as a blank. In a similar way, the corner punch device 100 punches out corner pieces from media sheets to provide differently shaped corners.

FIG. 2 is a drawing showing some of the components of the example corner punch device 100 separated from one another. Referring generally to FIGS. 1 and 2, one component of device 100 comprises a base 102 that is to receive pieces of sheet material, or media sheets (e.g., greeting cards, photographic print paper, paper sheets, other printable media cards or papers, etc.). Another component of a corner punch device 100 comprises a handle 104 that is rotatably coupled to the handle at a hinge joint 106. The handle 104 and base 102 are coupled together with a hinge pin 108 that is inserted through coaxial holes 110 positioned at the location of the hinge joint 106 on both the handle 104 and the base 102.

Application of a compressive force to the top of the handle 104 while the base 102 is held stationary, such as when the device is resting on a table top, moves the handle 104 toward the base 102 in a rotating motion 112 around the hinge joint 106. The handle 104 moves back to its initial resting position, and is maintained in this resting position, under a repulsive force provided by an elastic element 113, such as a coil spring 113. As shown in the example corner punch device 100 of FIGS. 1 and 2, coil springs 113 are positioned on spring mounts 115 of the device 100. The springs 122 enable the moveable handle 104 and base 102 to converge to a punching position when a compressive force applied to the handle 104 overcomes the repulsive force of the springs 113. When the compressive force is removed, the repulsive force of the springs 113 push the handle 104 and base 102 back apart from one another to their initial resting positions.

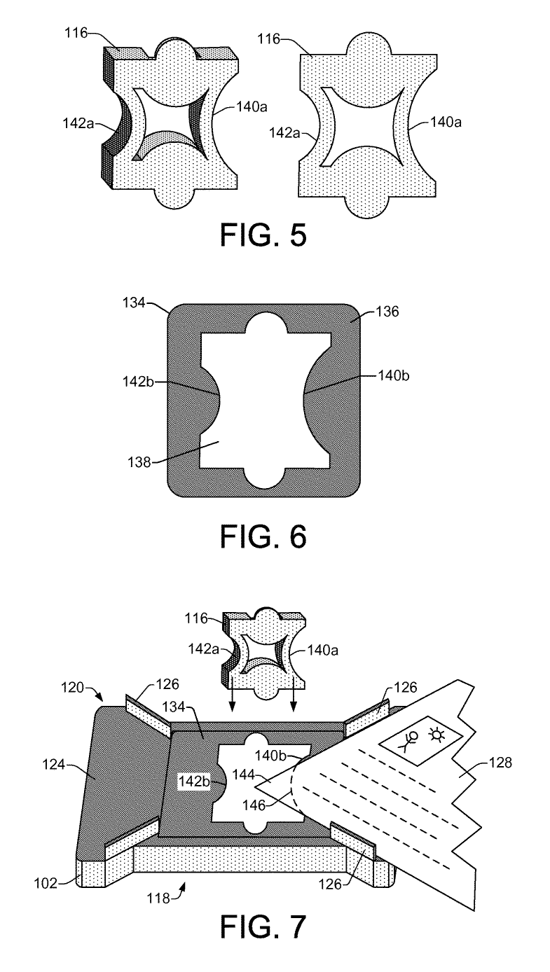

The handle 102 can include a protruding area, or berm 114, on its underside that contacts a punch piece 116 as the handle 104 rotates and moves toward the base 102. FIG. 5 shows a perspective view and a top down view of the example punch piece 116 from FIGS. 1 and 2. In some examples the punch piece 116 is coupled to the handle 104, with or without the berm 114 present, and moves with the handle as the handle moves toward the base. In some examples the punch piece 116 is held in place as the handle 104 remains in an initial resting position with the berm 114 resting against the punch piece 116. In any case, the movement of the handle 104 toward the base 102 also moves the punch piece 116 toward the base 102.

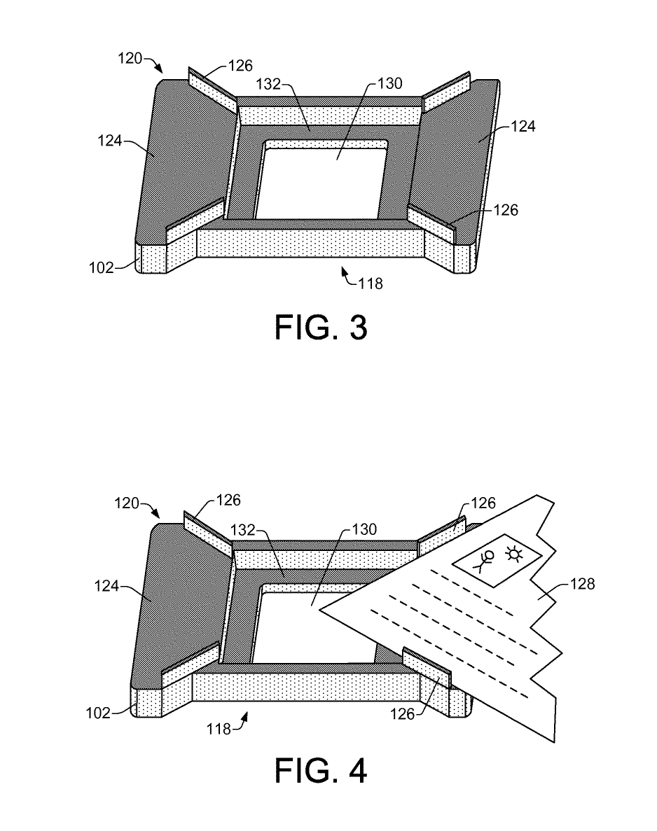

FIG. 3 shows a portion of the base 102 of the example corner punch device 100. Referring now generally to FIGS. 1-3, the base 102 is mostly rectangular in shape and can have widened areas at one or both ends to accommodate media guide areas 124, discussed below. In some examples, the base can have other shapes such as a square shape to accommodate additional media guide areas 124. The base 102 has an underside 118, or bottom surface 118, that is mostly flat to enable it to rest against a flat surface such as a table top. On its upper side 120, or top surface 120, the base 102 includes connection arms 122 (not shown in FIG. 3) that have coaxial holes 110 to receive a hinge pin 108 to couple the base 102 to the handle 104, as discussed above.

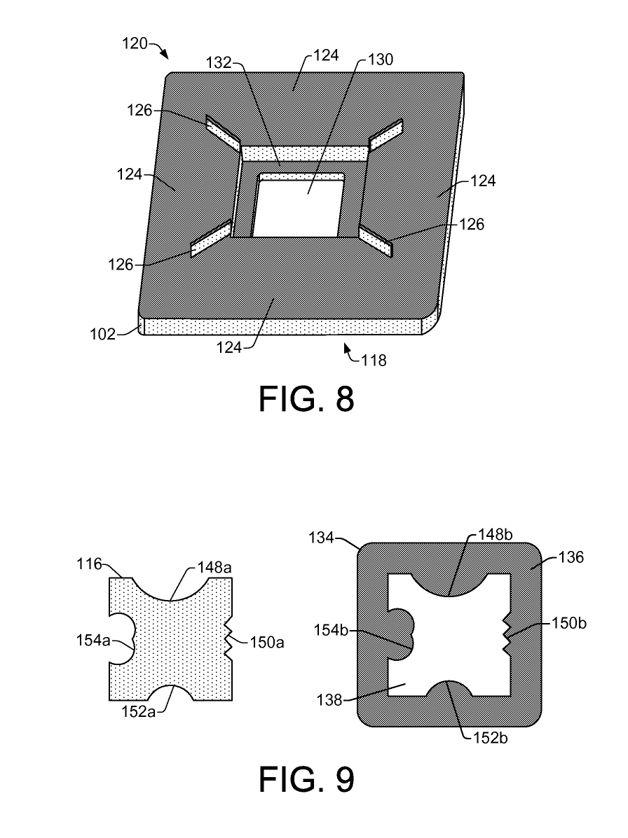

The base 102 includes multiple media guide areas 124 positioned on its upper side 120. The media guide areas 124 comprise flat surface areas on which a media sheet, or media sheets, can be positioned in preparation for punching the corners of the media sheets. While two media guide areas 124 are shown in FIGS. 1-3, other base configurations are possible that include additional media guide areas 124, as discussed below with respect to FIGS. 8 and 9. Each media guide area 124 is associated with two media guides 126 positioned at the edges of the media guide area 124. The media guides 126 facilitate the alignment of media sheets within the media guide areas 124 so that the media sheets are properly positioned to have their corners punched.

FIG. 4 shows an example of a sample media sheet 128 being positioned within a media guide area 124. As shown in FIG. 4, as the media sheet 128 is being moved or positioned within the media guide area 124, the media guides 126 at the edges of the media guide area 124 facilitate the alignment of the media sheet 128 so that its corner is squarely within the media guide area 124. This alignment properly positions the media sheet 128 to have its corner punched.

Referring generally to FIGS. 1-4, the base 102 has a centrally located opening 130 or cavity 130 that extends through the base from its top surface 120 to its bottom surface 118. Around the perimeter of the cavity 130, the base 102 includes a frame 132 or edge 132. The frame 132 is arranged to accept a die piece 134 such as the die piece 134 shown in FIG. 6.

As noted above, FIG. 5 shows a perspective view and a top down view of the example punch piece 116 from FIGS. 1 and 2. FIG. 6 shows a top down view of a die piece 134 that corresponds with the punch piece of FIG. 5. The die piece 134 includes a die frame 136 and a die opening 138 and can be fixed within the frame 132 of the base 102.

Referring to FIGS. 5 and 6, the die piece 134 corresponds with the punch piece 116 because its die opening 138 has a perimeter profile or contour that accommodates the profile of the punch piece 116. The punch piece 116, or male piece, is shaped to fit within the complementary die piece 134, or female piece, with a very small clearance that facilitates the punching of corners off of media sheets that are positioned within the media guide areas 124.

FIG. 7 illustrates an example of a process of punching a corner of a media sheet. As noted above, the die piece 134 is fixed within the frame 132 of the base 102. Thus, when the handle 104 is moved toward the base 102, the handle 104 moves the punch piece 116 toward the die piece 134 and eventually presses the punch piece 116 down far enough to intersect the die piece 134 and then partially enter the die piece 134. When a media sheet 128 (or media sheets) is properly positioned within a media guide area 124, as shown in FIG. 7, the motion of the punch piece 134 into the die piece 134 punches out the square corner 144 of the media sheet 128, leaving the media sheet with a corner that is shaped according to the punch and die profile, 140a and 140b, respectively. The resulting corner shape of the punched media sheet 128 is shown with a dashed line 146.

The corner punch device 100 has multiple corner punch profiles that are simultaneously active to punch one or multiple corners of different media sheets at the same time with a single pressing of the handle 104 to the base 102. In the current examples discussed with regard to FIGS. 1-7, the corner punch device 100 has two corner punch profiles, 140 and 142. The corner punch profiles 140 and 142 are implemented by the punch and die pieces, 116 and 134, which comprise corresponding profiles. Thus, the punch piece 116 comprises two “male” punch profiles illustrated as 140a and 142a, and the complementary die piece 134 comprises two counterpart or “female” die profiles illustrated as 140b and 142b.

In these examples, the two punch and die profiles, 140 and 142, are substantially circular in shape. More specifically, both the punch and die profiles (140 and 142) comprise a semi-circular shape, with a first profile (illustrated as punch profile 140a and die profile 140b) having a first radius of curvature, and a second profile (illustrated as punch profile 142a and die profile 142b) having a second radius of curvature that is smaller than the first radius of curvature. Examples of some popular corner profile curvatures include diameters of 5 and 10 millimeters. While the current examples shown in FIGS. 5-7 demonstrate circular punch and die profiles with varying curvature sizes, a variety of other corner punching profiles are possible. Such corner punching profiles can include, but are not limited to, star shaped profiles, heart shaped profiles, lace shaped profiles, and so on.

For each corner punch profile, the base 102 of the corner punch device 100 comprises a corresponding media guide area 124 to receive a media sheet in preparation to punch a corner of the media sheet. Thus, in the examples discussed with regard to FIGS. 1-7, the base 102 comprises two media guide areas 124 to accommodate the two corner punch profiles (140 and 142). The two media guide areas 124 are oriented on the base 102 approximately 180 degrees apart from one another in order to match up with their associated corner punch profiles (140 and 142), which are also oriented on the punch piece 116 and die piece 134 approximately 180 degrees from one another.

FIG. 8 shows an example of a base 102 comprising four media guide areas 124 to accommodate four corner punch profiles (see FIG. 9 discussion below). In this example, the base 102 is square rather than rectangular in order to provide additional space for the two additional media guide areas 124. The four media guide areas 124 are oriented on the base 102 approximately 90 degrees apart from one another in order to match up with associated corner punch profiles. As in examples described above, each media guide area 124 is associated with two media guides 126 at the edges of the media guide area that facilitate the alignment of media sheets within the media guide areas 124. Each media guide area 124 shares its associated media guides 126 with two adjacent media guide areas 124. In the example base 102, a separate media sheet can be received at each of the four different media guide areas 124 at the same time. The corners of the four separate media sheets can be punched simultaneously with four different corner punch profiles (discussed below with respect to FIG. 9) through a single movement of the handle 104 toward the base 102, as generally described above. As in the previous examples, the base 102 of FIG. 8 comprises a cavity 130 that extends through the base from its top surface 120 to its bottom surface 118. Around the perimeter of the cavity 130, the base 102 includes a frame 132. The frame 132 is arranged to accept a die piece 134 such as the die piece 134 shown in FIG. 9.

FIG. 9 shows an example of a punch piece 116 and die piece 134 that comprise four corresponding corner punch profiles 148, 150, 152, and 154. Thus, the punch piece 116 comprises four “male” punch profiles illustrated as 148a, 150a, 152a, and 154a, and the complementary die piece 134 comprises four counterpart or “female” die profiles illustrated as 148b, 150b, 152b, and 154b. The corner punch profiles 148 and 152 are substantially circular in shape, comprising semi-circles that each have a different radius of curvature. As noted above, examples of some popular corner profile curvatures include diameters of 5 and 10 millimeters. The corner punch profile 150 comprises a jagged or toothed shape, while the corner punch profile 154 comprises a heart shape. The four corner punch profiles 148, 150, 152, and 154, are oriented on the punch and die pieces approximately 90 degrees apart from one another.

As noted in the examples above, the die piece 134 is fixed within the frame 132 of the base 102. Thus, when the handle 104 is moved toward the base 102, the handle 104 moves the punch piece 116 toward the die piece 134 and eventually presses the punch piece 116 down far enough to intersect the die piece 134 and then partially enter the die piece 134. The motion of the punch piece 134 into the die piece 134 punches out the corners of any media sheets that are positioned within the media guide areas 124 as shown in FIG. 8. The multiple (four) corner punch profiles 148, 150, 152, and 154, are persistently active and ready to punch media sheet corners, without a user having to adjust the corner punch device 100 in order to select different profiles. Thus, an example corner punch device 100 comprising the base 102 in FIG. 8 and the punch piece 116 and die piece 134 shown in FIG. 9, enables a user to punch up to four different corner shapes into four different media sheets simultaneously, with a single depression of the handle 104 toward the base 102 of the device 100. In addition, more than one media sheet can be positioned within a media guide area 124 at the same time, enabling multiple sheets to be punched with different corner shapes at the same time.

What is claimed is:

1. A corner punch device comprising:
a base;
a handle rotatably coupled to the base;
a die piece fixed to the base; and
a punch piece moveable by the handle toward the die piece, the punch piece comprising multiple punch profiles that are active to punch distinct shapes into separate media sheets simultaneously.

2. A device as in claim 1, wherein the die piece comprises multiple die profiles that correspond with the multiple punch profiles, the device further comprising:
for each die profile, an associated media guide area to receive a media sheet in preparation to punch a corner of the media sheet.

3. A device as in claim 2, wherein the die piece comprises clearance to enable each of the punch profiles to enter a corresponding one of the die profiles when the handle moves the punch piece toward the base.

4. A device as in claim 1, wherein each punch profile is a different shape to punch a distinct shape into a corner of a media sheet.

5. A device as in claim 1, further comprising a hinge pin disposed through coaxial holes of the handle and base to rotatably couple the handle to the base.

6. A device as in claim 2, wherein each media guide area comprises two media guides to align a corner of a media sheet with a die profile as the media sheet is received at the media guide area.

7. A device as in claim 1, wherein the multiple die profiles comprise two profiles disposed in the die piece approximately 180 degrees apart from one another.

8. A device as in claim 1, wherein the multiple die profiles comprise four profiles disposed in the die piece approximately 90 degrees apart from one another.

9. A device as in claim 1, wherein each punch profile comprises a substantially circular shape with a different radius of curvature than the other punch profiles.

10. A device as in claim 1, further comprising an elastic component disposed between the handle and the base to repel the handle away from the base.

11. A device for punching a corner of a media sheet, comprising:
a punch piece;
a die piece to receive the punch piece;
a base to support the die piece; and
a handle rotatably hinged to the base to press the punch piece into the die piece to form a different corner shape on each of multiple media sheets at the same time.

12. A device as in claim 11, wherein the punch and die pieces have multiple corresponding profiles to form different corner shapes simultaneously when the handle is rotated to press the punch piece into the die piece.

13. A device as in claim 12, further comprising:
a media guide area corresponding with each of the profiles to receive a media sheet;
two media guides associated with each media guide to guide a corner of the media sheet to a profile.

14. A device as in claim 12, further comprising a coil spring disposed between the handle and the base to return the handle to an initial resting position after pressing the punch piece into the die piece.

15. A corner punch device comprising:
multiple media guide areas to receive multiple media sheets;
media guides associated with each media guide area to guide corners of the media sheets to a punching position;
a distinct punch and die profile associated with each media guide area;
a handle to press a punch piece into a die piece to punch the corners of the media sheets with shapes that correspond to the punch and die profiles.
